(19) United States
(12) Patent Application Publication
(10) Pub. No.: US 2026/0299772 A1
(43) Pub. Date: Oct. 1, 2026

(54) PROCESSING INFORMATION DISPLAY DEVICE

(71) Applicant: FANUC CORPORATION, Minamitsuru-gun, Yamanashi (JP)

(72) Inventors: Daisuke UENISHI, Minamitsuru-gun, Yamanashi (JP); Yasuaki KOYAMA, Minamitsuru-gun, Yamanashi (JP); Takahiro ENDOU, Minamitsuru-gun, Yamanashi (JP)

(73) Assignee: FANUC CORPORATION, Minamitsuru-gun, Yamanashi (JP)

(21) Appl. No.: 19/475,652

(22) PCT Filed: May 9, 2023
(86) PCT No.: PCT/JP2023/017482

§ 371 Date: Oct. 15, 2025

(51) Int. Cl. G06F 3/04847; G06F 3/14

(52) U.S. Cl. CPC G06F 3/04847; G06F 3/14

(57) ABSTRACT

Provided is a processing information display device in which a processing mode of a machine tool can be easily selected, and with which efficient processing can be performed regardless of the skill level of a user. This processing information display device includes at least two processing modes each defining a combination of parameters of at least one of an acceleration/deceleration function, a servo function, and a correction function which are required for processing by a machine tool, and comprises a display control unit for displaying information related to the processing modes on the display device. The processing modes are classified into one or more types of workpieces according to processing. The display control unit displays one or more processing type images for selecting the one or more processing types, and, when one processing type from among the one or more processing types is selected, displays an image indicating the processing modes set for the processing type.

### TECHNICAL FIELD

The present disclosure relates to a machining information display device.

### BACKGROUND ART

Conventionally, operating a machine tool to machine a workpiece sometimes involves setting optimal acceleration/deceleration parameters depending on a machining object or a machining method employed. For milling workpieces such as automotive parts, where contour accuracy is not required, acceleration/deceleration parameters that allow for high speed operation are needed. By contrast, for mold machining such as electrode machining, where contour accuracy is required, acceleration/deceleration parameters that allow for high contour accuracy are needed.

As such, efficient machining has conventionally been achieved by changing acceleration/deceleration parameters as appropriate to suit the machining object or the machining method. However, changing parameters depending on the machining object requires the expertise of a skilled operator well-versed in both machining with a machine tool and operating a numerical control device.

Taking such circumstances into account, a conventional numerical control device is equipped with a machining mode setting function, storing combinations of acceleration/deceleration parameters predefined based on motion characteristics of a machine tool. Thus, the numerical control device allows even a non-skilled user to collectively change acceleration/deceleration parameters on a per machining object basis by selecting a pattern as appropriate on a screen of a display device of the numerical control device or by issuing an M-code command. Such a technique is disclosed, for example, in Patent Document 1.

### CITATION LIST

### Patent Document

Patent Document 1: Japanese Unexamined Patent Application, Publication No. 2002-172543

### DISCLOSURE OF THE INVENTION

### Problems to be Solved by the Invention

There is a demand for a technique that makes it possible to easily select a machining mode for a machine tool regardless of the user's skill level, thereby facilitating efficient machining.

### Means for Solving the Problems

An aspect of the present disclosure is directed to a machining information display device having at least two machining modes each defining a combination of parameters of at least one of an acceleration/deceleration function, a servo function, or a compensation function required for machining with a machine tool, the machining information display device including a display control unit that displays, on a display device, a machining mode image showing characteristics of any of the machining modes in a predetermined display format recognizable by a user based on indicators related to the machining, wherein the display control unit displays an adjustment image for adjusting parameters that affect the indicators along with the machining mode image displayed in the predetermined display format.

### BRIEF DESCRIPTION OF THE DRAWINGS

FIG. 1 is a block diagram illustrating a configuration of a numerical control device, which serves as a machining information display device according to an embodiment of the present disclosure;

FIG. 2 illustrates a display screen showing an example of an adjustment screen according to the present embodiment;

FIG. 3 illustrates a display screen showing an example of the adjustment screen according to the present embodiment;

FIG. 4 is a diagram showing a list of parameters of a machining mode;

FIG. 5 is a diagram showing examples of per-level parameter setting values;

FIG. 6 is a diagram showing an example of a mathematical function defining a parameter and adjustment range levels thereof;

FIG. 7 is a diagram showing an example in which the adjustment range levels are switched between integer and floating-point values;

FIG. 8 shows an example in which characteristics of a machining mode are shown using pie charts;

FIG. 9 shows an example in which characteristics of a machining mode are shown using block-style gauge charts;

FIG. 10 is a diagram showing an example of a function for resetting settings for the levels to default;

FIG. 11 is a diagram showing an example of a function for inputting and outputting settings for the levels;

FIG. 12 is a diagram showing examples of variations of an adjustment image;

FIG. 13 is a diagram showing an example of a function for collectively adjusting multiple parameters of a machining mode;

FIG. 14 is a diagram showing an example of the function for collectively adjusting multiple parameters of the machining mode that are related to an indicator “Cycle time reduction”;

FIG. 15 is a diagram showing an example of a display screen displayed after the multiple parameters of the machining mode that are related to the indicator “Cycle time reduction” have been collectively adjusted;

FIG. 16 is a diagram showing an example of a list of parameters;

FIG. 17 is a diagram showing an example of a comparison table of parameters;

FIG. 18 is a diagram illustrating a display screen displayed upon an operation being performed on an indicator displayed using a radar chart;

FIG. 19 is a diagram showing an example of priority levels of parameters of a machining mode for each indicator; and

FIG. 20 is a diagram showing an example of distribution ratios of parameters of a machining mode for each indicator.

### PREFERRED MODE FOR CARRYING OUT THE INVENTION

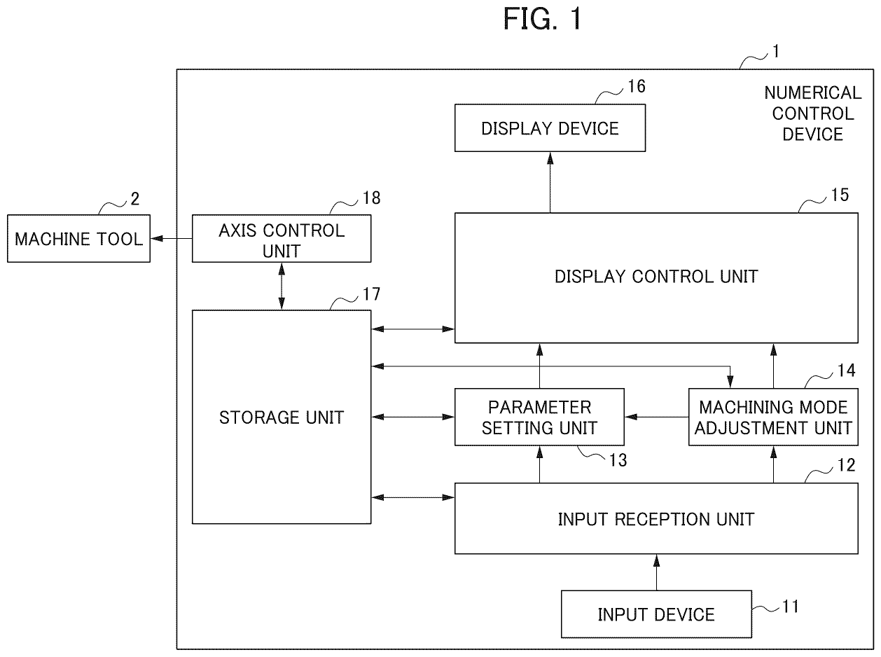

The following describes an example of an embodiment of the present disclosure. FIG. 1 is a block diagram illustrating a configuration of a numerical control device 1, which serves as a machining information display device according to an embodiment of the present disclosure.

The machining information display device displays information pertaining to machining of a workpiece with a tool. The machining information display device may be implemented by causing one or more computer devices having memory, a processor, an input/output interface, and the like to execute an appropriate control program. Specific examples of machining information display devices other than the numerical control device 1 that controls a machine tool 2 described below include devices obtained by adding functions described below to a machining simulator that simulates the operation of a machine tool or a management computer that manages a plurality of machine tools.

The numerical control device 1 is used to control the machine tool 2, and thus cause the machine tool 2 to perform a predetermined machining or other operation. Note here that the machine tool 2 may be, for example, a machining center having a plurality of drive axes.

The numerical control device 1 includes an input device 11, an input reception unit 12, a parameter setting unit 13, a machining mode adjustment unit 14, a display control unit 15, a display device 16, a storage unit 17, and an axis control unit 18.

The input reception unit 12, the parameter setting unit 13, the machining mode adjustment unit 14, the display control unit 15, and the axis control unit 18 are functions that are implemented by a controller of the numerical control device 1. In other words, the controller includes one or more processors, such as a central processing unit (CPU), and implements these functions by executing a program stored in the storage unit 17.

The storage unit 17 includes storage devices such as read only memory (ROM), random access memory (RAM), a hard disk drive (HDD), and a solid state drive (SSD), and stores various types of information therein. In the present embodiment, the storage unit 17 is provided in the numerical control device 1. Alternatively, the storage unit 17 may be provided in an electronic device or a server external to the numerical control device 1.

The display device 16 displays various types of information based on signals transmitted from the display control unit 15. The display device 16 includes, for example, a liquid crystal display (LCD), an organic electroluminescent (EL) display, or a cathode-ray tube (CRT) display. In the present embodiment, the display device 16 is provided in the numerical control device 1. Alternatively, the display device 16 may be, for example, an external electronic device or an external display device that is connected to the numerical control device 1.

The input device 11 includes, for example, buttons, keys, switches, a keyboard, a mouse, and a teach pendant, and receives various input operations from a user. It should be noted that the input device 11 and the display device 16 may be a teach pendant having an integrated touch panel or the like. The teach pendant may be implemented using a tablet terminal.

The input reception unit 12 receives input operations entered using the input device 11 and provides information corresponding to the input operations to the parameter setting unit 13, the machining mode adjustment unit 14, the display control unit 15, the axis control unit 18, and the storage unit 17. The parameter setting unit 13 calculates and sets parameters related to machining modes based on input operations received by the input reception unit 12 and various types of information stored in the storage unit 17.

The machining mode adjustment unit 14 adjusts settings related to the machining modes based on input operations received by the input reception unit 12 and various types of information stored in the storage unit 17. The display control unit 15 displays information pertaining to the machining modes on the display device 16. The axis control unit 18 controls drive axes of the machine tool 2 such as a spindle and feed axes.

The numerical control device 1 according to the present embodiment has at least two machining modes each defining a combination of parameters of at least one of an acceleration/deceleration function, a servo function, or a compensation function required for machining with the machine tool 2, and the display control unit 15 displays, on the display device 16, a machining mode image showing characteristics of any of the machining modes in a predetermined display format recognizable by a user based on indicators related to the machining. The display control unit 15 displays an adjustment image for adjusting parameters that affect the indicators along with the machining mode image displayed in the predetermined display format.

The adjustment image includes one or more adjustment items (for example, user interfaces (UIs) for parameter adjustment such as sliders) for adjusting the parameters of at least one of the acceleration/deceleration function, the servo function, or the compensation function. The one or more adjustment items (for example, sliders) are set for the respective parameters of the machining mode and allow the parameters to be adjusted on a display screen. Each adjustment item (for example, a slider) has preset adjustment range levels for adjustment of the corresponding parameter within an adjustment range, and a parameter value is defined for each of the adjustment range levels. Upon an adjustment range level of a parameter of the machining mode being selected by operating the adjustment item (for example, a slider), the parameter setting unit 13 changes the parameter of the machining mode.

Machining types include Parts, Shape/Mold, IT, and Four-axis or Five-axis. An image showing the machining mode is represented in one of the following display formats: a radar chart, a pie chart, a block-style gauge chart, and a map. Each machining mode defines a combination of parameters of at least one of the acceleration/deceleration function, the servo function, or the compensation function required for machining with the machine tool 2. Examples of machining modes include Standard, High-speed, Contour machining, and Low-vibration.

The acceleration/deceleration function refers to a function related to control for accelerating and decelerating drive axes such as the spindle and the feed axes or a function related to control of overlap, tap retraction speed, and the like. The servo function refers to a function related to servo motor control. For example, gains that improve the tracking performance of motors in response to commands fall under the servo function. The compensation function refers to a function related to control for compensation or correction of machining programs, cutter marks, TCP, and the like.

Indicators related to the machining are used as references for judging or evaluating the machining with the machine tool 2. Examples of such indicators include Cycle time reduction, Vibration suppression, Overlap, Smoothness, Accuracy, Tapping speed, Program correction, Cutter mark compensation, and Tool center point (TCP) control function.

The machining modes are classified into machining types based on machining. Note here that the machining types refer to types of the combinations of parameters of at least one of the acceleration/deceleration function, the servo function, or the compensation function depending on the machining object. The machining types include, for example, Parts, Shape/Mold, IT, and Four-axis or Five-axis. The display control unit 15 displays, on the display device 16, the machining modes on a per machining type basis.

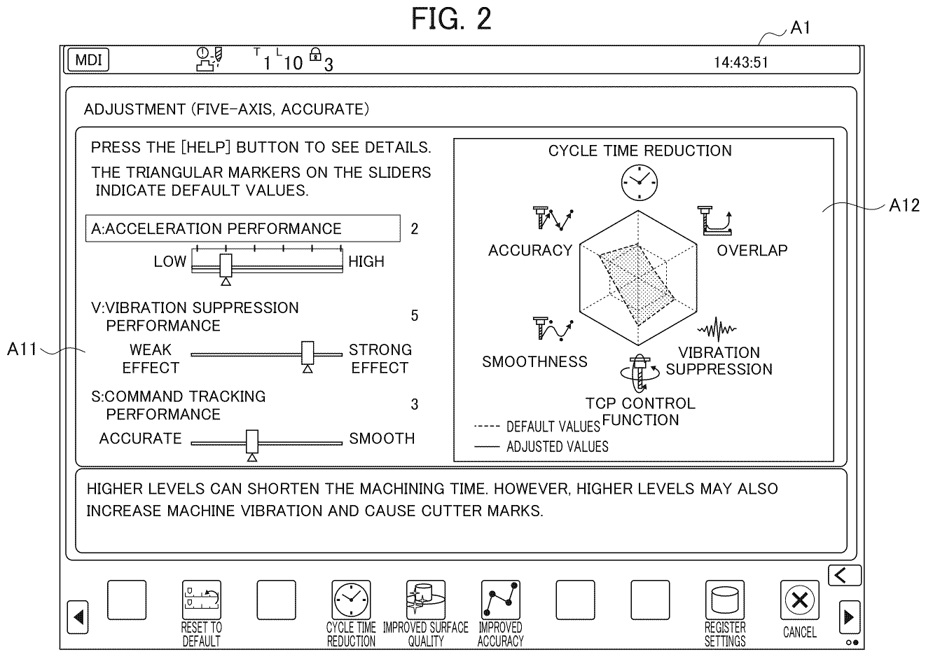

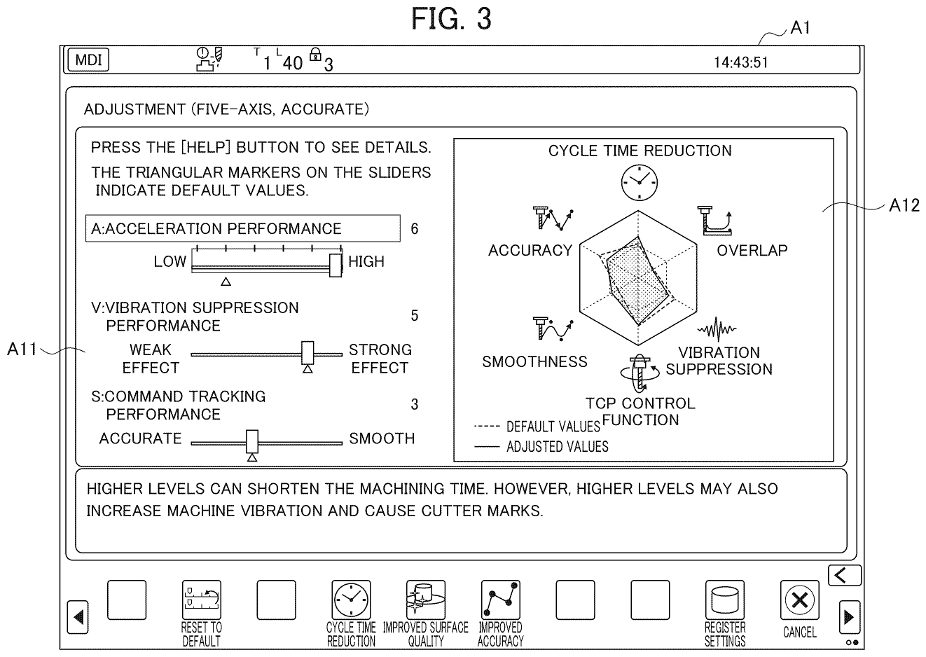

FIGS. 2 and 3 are each a diagram illustrating a display screen A1 showing an example of an adjustment screen according to the present embodiment. The display screen A1 shown in FIGS. 2 and 3 includes an image A11 (adjustment image) that is displayed on the left side of the screen and includes sliders for adjusting parameters (for example, Acceleration performance) of a machining mode, and an image A12 that is displayed on the right side of the screen and shows characteristics of the machining mode using a radar chart. The display screen A1 also includes an image that is displayed on the lower side of the screen and used to select various functions.

On the image A11 in FIG. 2, the values of the parameters “Acceleration performance”, “Vibration suppression performance”, and “Command tracking performance” of the machining mode can be changed using sliders, and the thus changed parameters are reflected in the radar chart in the image A12. Specifically, in the image A11 in FIG. 2, the parameter “Acceleration performance” of the machining mode is at Level 2. Upon the parameter “Acceleration performance” of the machining mode being changed from Level 2 to Level 6 as shown in the image A11 in FIG. 3, the changed parameter is reflected in the radar chart in the image A12 as shown in the image A12 in FIG. 3.

In FIG. 2, the parameter “Acceleration performance” of the machining mode is assigned the symbol “A”, and the current level of the parameter is “2”. Similarly, the parameter “Vibration suppression performance” of the machining mode is assigned the symbol “V”, and the current level of the parameter is “5”. The parameter “Command tracking performance” of the machining mode is assigned the symbol “S”, and the current level of the parameter is “3”.

The image A12 shows a radar chart corresponding to a case where the machining type is “Five-axis” and the machining mode is “Accurate”. The radar chart shown in the image A12 shows a score for each of the indicators, Cycle time reduction, Overlap, Vibration suppression, TCP control function, Smoothness, and Accuracy.

Furthermore, the display control unit 15 displays icons related to the respective indicators and names of the respective indicators at vertices of the radar chart in the image A12.

The adjustment image such as the image A11 may be assigned one or more of alphanumeric characters and/or symbols, icons, or colors for identifying the machining type. For example, the numerical control device 1 assigns one alphabet character that matches the machining type to the adjustment image, and the alphabet character is used as an argument for a program-based change. Thus, the user can recognize the machining type more easily.

Furthermore, the adjustment image includes markers indicating default values of the parameters of the machining mode. Specifically, the adjustment image, such as the image A11, includes triangular markers indicating default values of the parameters of the machining mode in images of the sliders.

It should be noted that the machining types and the machining modes described above may be set, created, or added by the user as appropriate. For example, the machining mode adjustment unit 14 may set, create, or add a machining type or a machining mode as appropriate based on an input operation received by the input reception unit 12, and the display control unit 15 may display the set, created, or added machining type or machining mode on the display device 16.

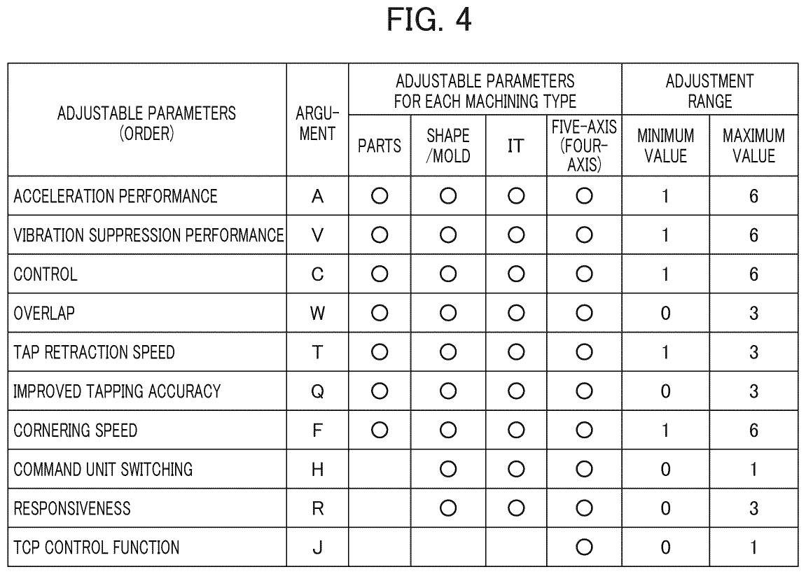

FIG. 4 is a diagram showing a list of parameters of a machining mode. As shown in FIG. 4, the parameters of the machining mode include, for example, Acceleration performance, Vibration suppression performance, Control, Overlap, Tap retraction speed, Improved tapping accuracy, Cornering speed, Command unit switching, Responsiveness, and TCP control function. Each of the parameters of the machining mode is associated with an argument, information indicating, for each machining type, whether or not the parameter is to be adjusted, and the maximum and minimum values of the adjustment range.

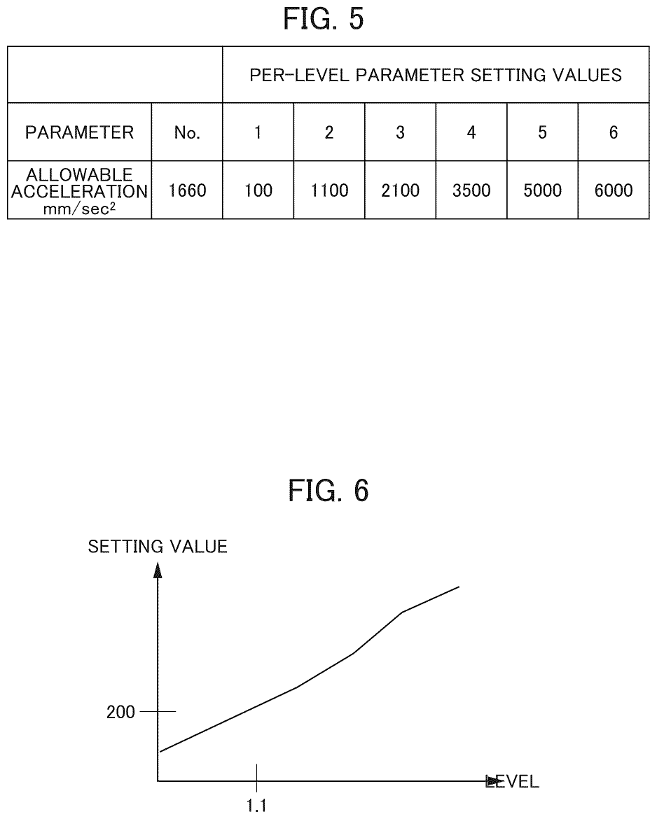

FIG. 5 is a diagram showing examples of per-level parameter setting values. As shown in FIG. 5, an allowable acceleration [mm/sec²] is set for each level (parameter) of Acceleration performance as a parameter of the machining mode.

The list of the parameters of the machining mode and the per-level parameter setting values shown in FIGS. 4 and 5 are stored in the storage unit 17. Upon an adjustment range level being selected by operating the slider, which is an adjustment item, the parameter setting unit 13 changes the parameter of the machining mode based on the list of the parameters of the machining mode and the per-level parameter setting values stored in the storage unit 17. The display control unit 15 displays the thus changed parameter and reflects the changed parameter in the radar chart.

Furthermore, the parameter setting unit 13 performs calculations of each parameter of the machining mode corresponding to the adjustment range levels for adjustment of the parameter within the adjustment range, based on a mathematical function defining the parameter and the adjustment range levels. FIG. 6 is a diagram showing an example of a mathematical function defining a parameter and adjustment range levels thereof. In FIG. 6, the horizontal axis indicates the adjustment range levels, and the vertical axis indicates the parameter setting values. Since the parameter and the adjustment range levels are defined by a mathematical function as described above, the levels can be set to decimal values. For example, the levels can be set to values such as 1.1 and 2.53.

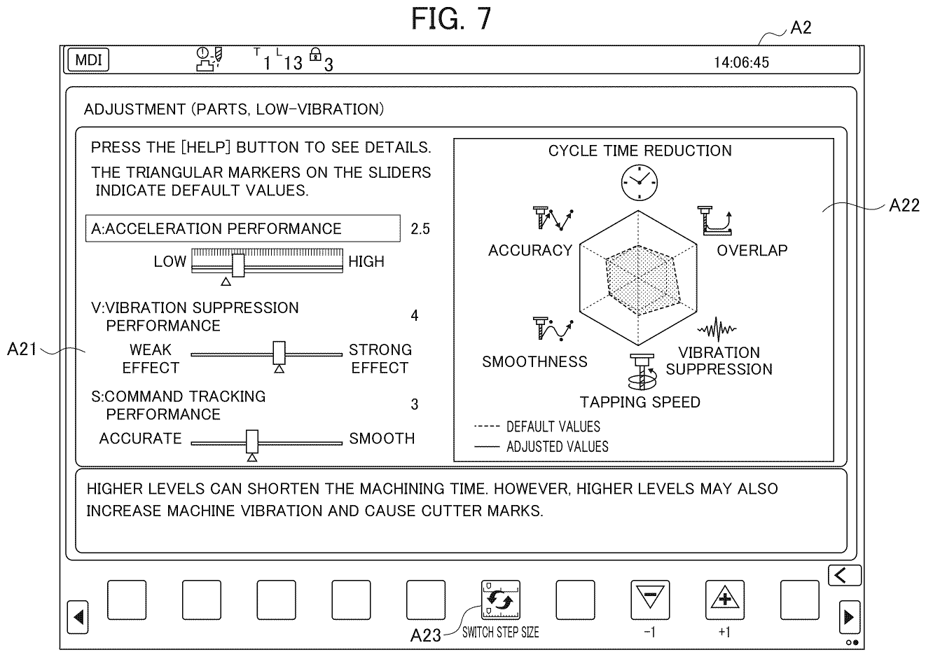

Furthermore, the machining mode adjustment unit 14 has a function for switching the adjustment range levels between integer and floating-point values. FIG. 7 is a diagram showing an example in which the adjustment range levels are switched between integer and floating-point values. A display screen A2 shown in FIG. 7 includes an image A21 that is displayed on the left side of the screen and includes sliders for adjusting parameters (for example, Acceleration performance) of a machining mode, and an image A22 that is displayed on the right side of the screen and shows characteristics of the machining mode using a radar chart. The display screen A2 also includes an image A23 that is displayed on the lower side of the screen and shows a software key for the function for switching the adjustment range levels between integer and floating-point values.

Upon the input reception unit 12 receiving an operation of the image A23 from the user, the machining mode adjustment unit 14 switches the adjustment range levels between integer and floating-point values. As a result, for example, the display of the adjustment range levels for Acceleration performance is switched from integer values to floating-point values or from floating-point values to integer values.

In the machining mode image showing the characteristics of the machining mode in the predetermined display format, the display control unit 15 changes and displays one or more of chart shape, numerical value of each indicator, icon or other graphic, or color according to the parameters of the machining mode that are varied using the adjustment items. Note here that the predetermined display format is one of a radar chart (see FIG. 2 and other drawings mentioned above), a pie chart, or a block-style gauge chart.

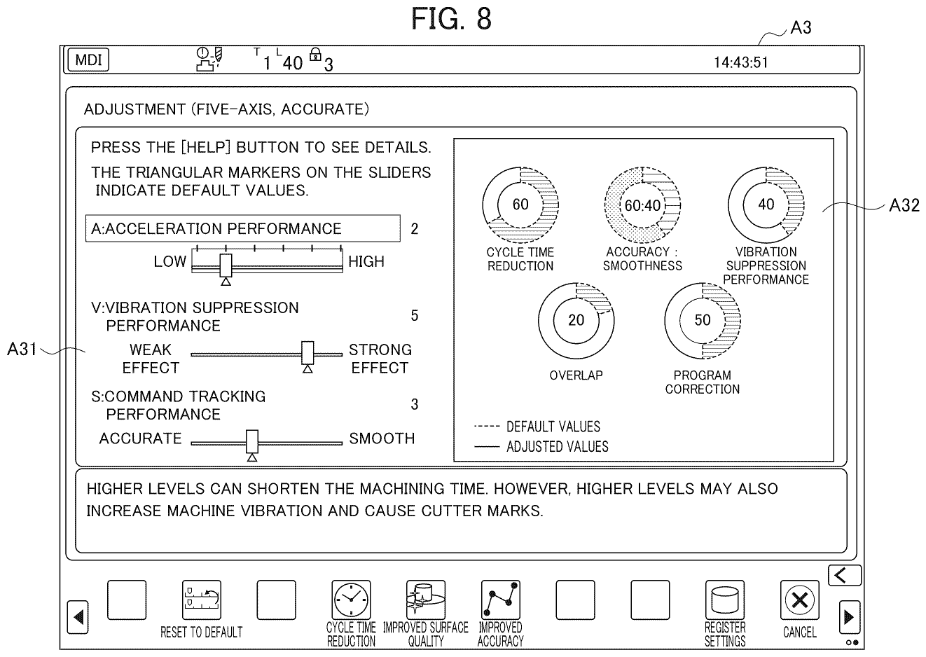

FIG. 8 shows an example in which characteristics of a machining mode are shown using pie charts. A display screen A3 shown in FIG. 8 includes an image A31 that is displayed on the left side of the screen and includes sliders for adjusting parameters (for example, Acceleration performance) of the machining mode, and an image A32 that is displayed on the right side of the screen and shows the characteristics of the machining mode using pie charts.

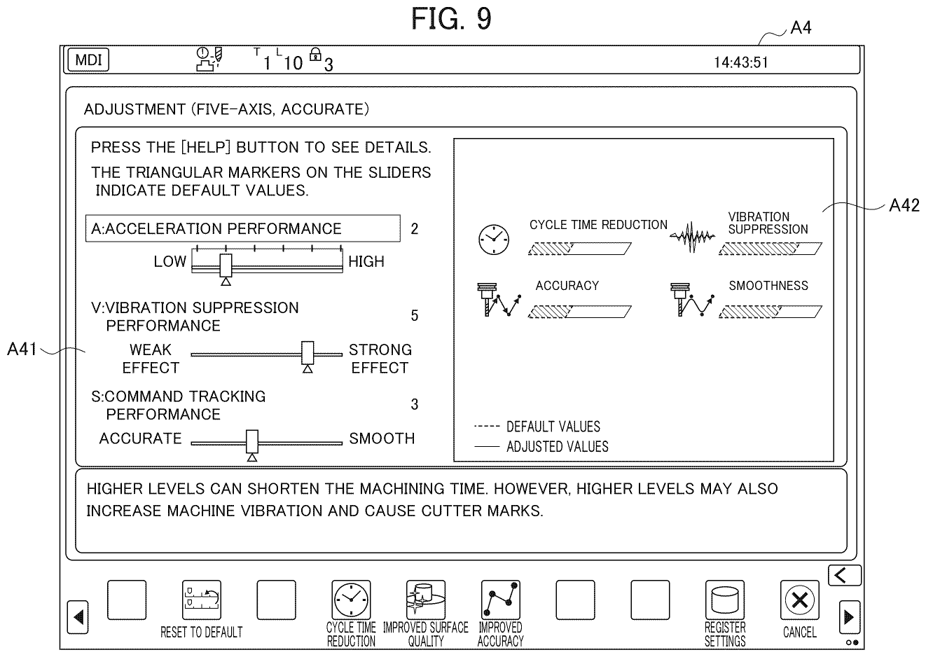

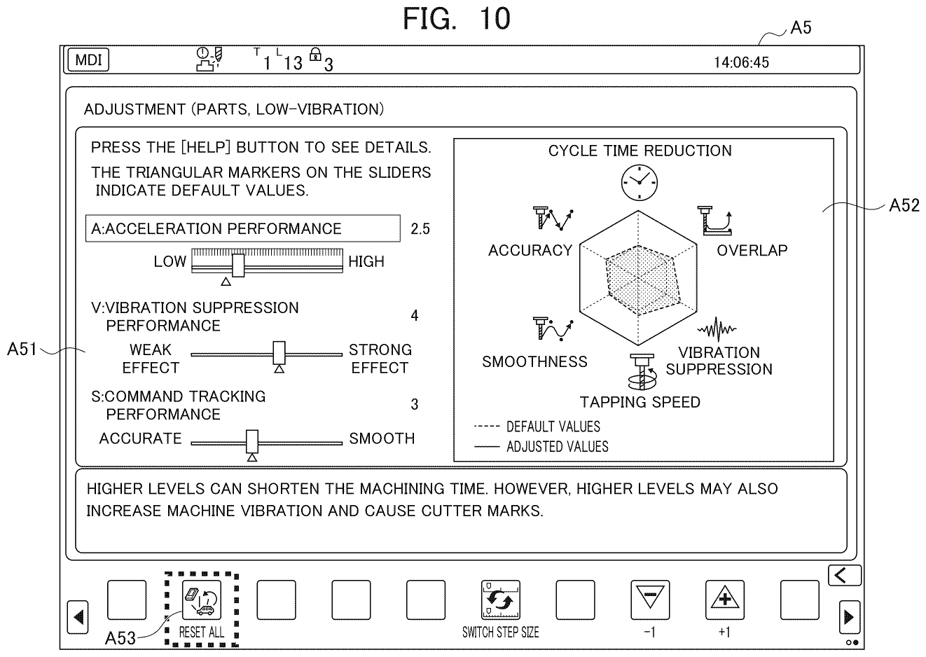

FIG. 9 shows an example in which characteristics of a machining mode are shown using block-style gauge charts. A display screen A4 shown in FIG. 9 includes an image A41 that is displayed on the left side of the screen and includes sliders for adjusting parameters (for example, Acceleration performance) of the machining mode, and an image A42 that is displayed on the right side of the screen and shows the characteristics of the machining mode using block-style gauge charts.

Furthermore, the machining mode adjustment unit 14 has a function for resetting settings for the adjustment range levels to default. FIG. 10 is a diagram showing an example of the function for resetting settings for the levels to default. A display screen A5 shown in FIG. 10 includes an image A51 that is displayed on the left side of the screen and includes sliders for adjusting parameters (for example, Acceleration performance) of a machining mode, and an image A52 that is displayed on the right side of the screen and shows characteristics of the machining mode using a radar chart. The display screen A5 also includes an image A53 that is displayed on the lower side of the screen and shows a software key for the function for resetting settings for the adjustment range levels to default.

Upon the input reception unit 12 receiving an operation of the image A53 from the user, the machining mode adjustment unit 14 resets the adjustment range levels for adjustment of the parameter of the machining mode, settings related to the other machining modes, and adjustment values related to the other machining modes.

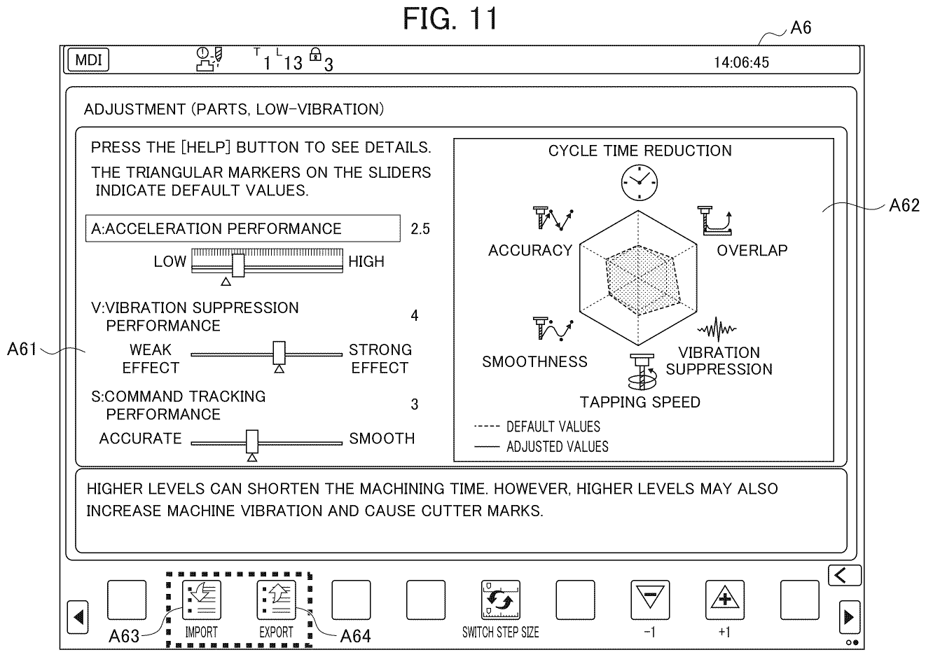

Furthermore, the machining mode adjustment unit 14 has a function for inputting and outputting settings for the adjustment range levels. FIG. 11 is a diagram showing an example of the function for inputting and outputting settings for the levels. A display screen A6 shown in FIG. 11 includes an image A61 that is displayed on the left side of the screen and includes sliders for adjusting parameters (for example, Acceleration performance) of a machining mode, and an image A62 that is displayed on the right side of the screen and shows characteristics of the machining mode using a radar chart.

The display screen A6 also includes an image A63 that is displayed on the lower side of the screen and shows a software key for the function for inputting (importing) settings for the adjustment range levels, and an image A64 that shows a software key for the function for outputting (exporting) settings for the adjustment range levels.

Upon the input reception unit 12 receiving an operation of the image A63 from the user, the machining mode adjustment unit 14 inputs (imports), from a designated folder, data in a predetermined format that contains the adjustment range levels, settings related to the other machining modes, and adjustment values related to the other machining modes. Upon the input reception unit 12 receiving an operation of the image A64 from the user, the machining mode adjustment unit 14 outputs (exports), to a designated folder, data in a predetermined format that contains the adjustment range levels, settings related to the other machining modes, and adjustment values related to the other machining modes.

Furthermore, the adjustment image may include sliders each including one of a bar, a block-style gauge, a triangular-style gauge, a cylindrical-style gauge, or a scroll bar, and the sliders may be each formed from a segmented or unsegmented triangle, rectangle, parallelogram, or cylinder.

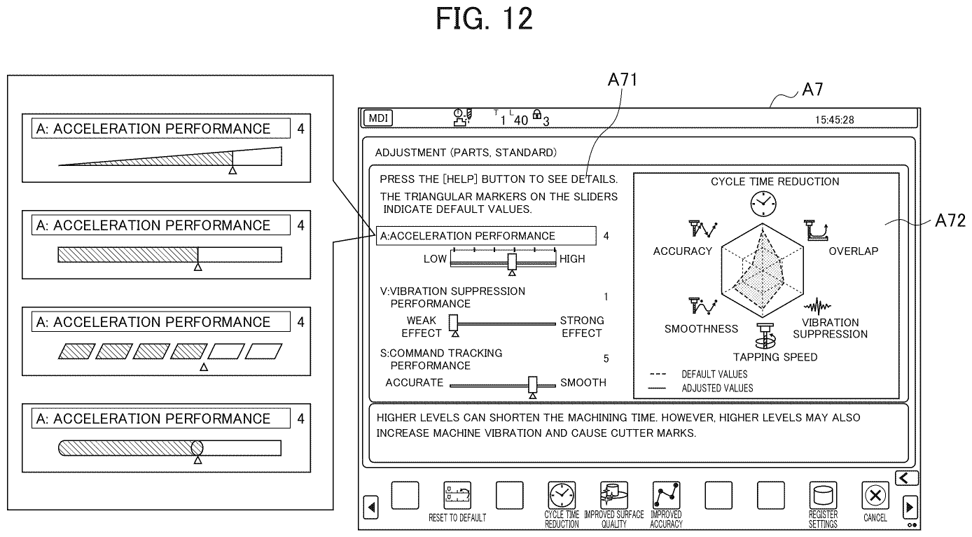

FIG. 12 is a diagram showing examples of variations of the adjustment image. A display screen A7 shown in FIG. 12 includes an image A71 that is displayed on the left side of the screen and includes sliders for adjusting parameters (for example, Acceleration performance) of a machining mode, and an image A72 that is displayed on the right side of the screen and shows characteristics of the machining mode using a radar chart. As shown in FIG. 12, the sliders in the image A71 displayed as an adjustment image may be each formed from one of a triangle, a rectangle, a segmented parallelogram, and a cylinder.

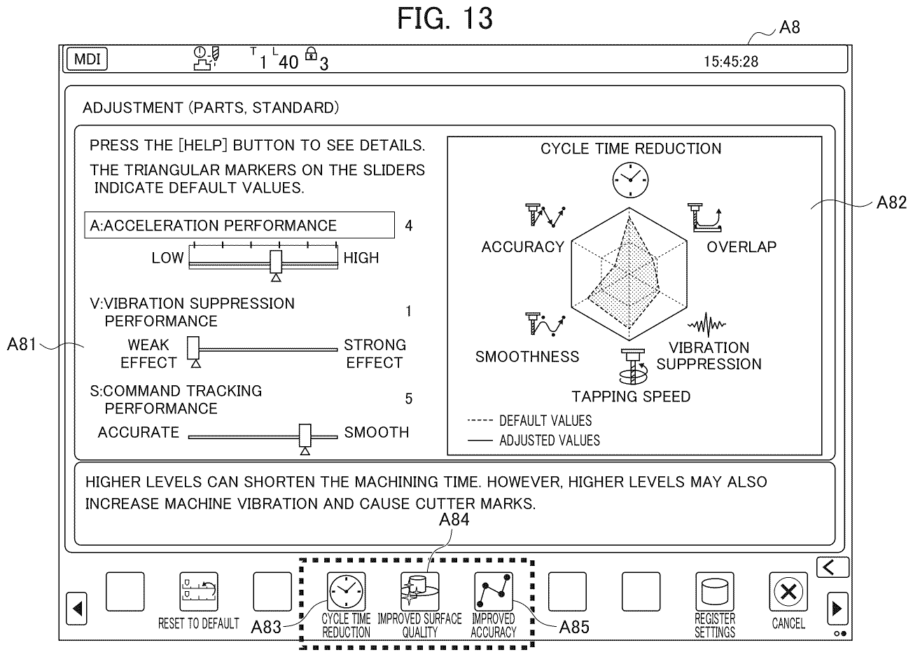

Furthermore, the machining mode adjustment unit 14 may have a function for collectively adjusting multiple parameters (for example, Acceleration performance, Vibration suppression performance, and Command tracking performance) of the machining mode. FIG. 13 is a diagram showing an example of the function for collectively adjusting multiple parameters of a machining mode.

A display screen A8 shown in FIG. 13 includes an image A81 that is displayed on the left side of the screen and includes sliders for adjusting parameters (for example, Acceleration performance) of a machining mode, and an image A82 that is displayed on the right side of the screen and shows characteristics of the machining mode using a radar chart. The display screen A8 also includes an image A83, an image A84, and an image A85 that are displayed on the lower side of the screen and show software keys for the function for collectively adjusting multiple parameters of the machining mode.

The image A83 is assigned the function for collectively adjusting multiple parameters of the machining mode that are related to the indicator “Cycle time reduction”. The image A84 is assigned the function for collectively adjusting multiple parameters of the machining mode that are related to the indicator “Improved surface quality”. The image A85 is assigned the function for collectively adjusting multiple parameters of the machining mode that are related to the indicator “Improved accuracy”.

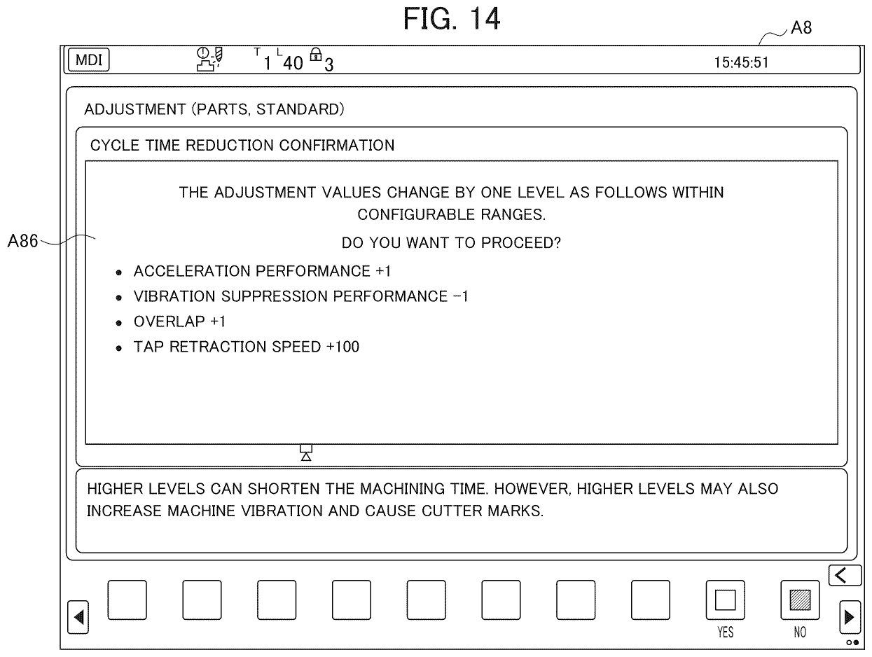

For example, upon the input reception unit 12 receiving an operation of the image A83 from the user, the display control unit 15 displays a message screen A86 on the display device 16 as shown in FIG. 14. FIG. 14 shows an example of the function for collectively adjusting the multiple parameters of the machining mode that are related to the indicator “Cycle time reduction”.

The message screen A86 includes an image indicating the following. “The adjustment values change by one level as follows within configurable ranges. Do you want to proceed?
Acceleration performance+1
Vibration suppression performance+1
Overlap+1
Tap retraction speed+100”
   Upon the input reception unit 12 receiving an approval operation by the user in response to this message, the machining mode adjustment unit 14 collectively adjusts the multiple parameters of the machining mode that are related to the indicator “Cycle time reduction”.

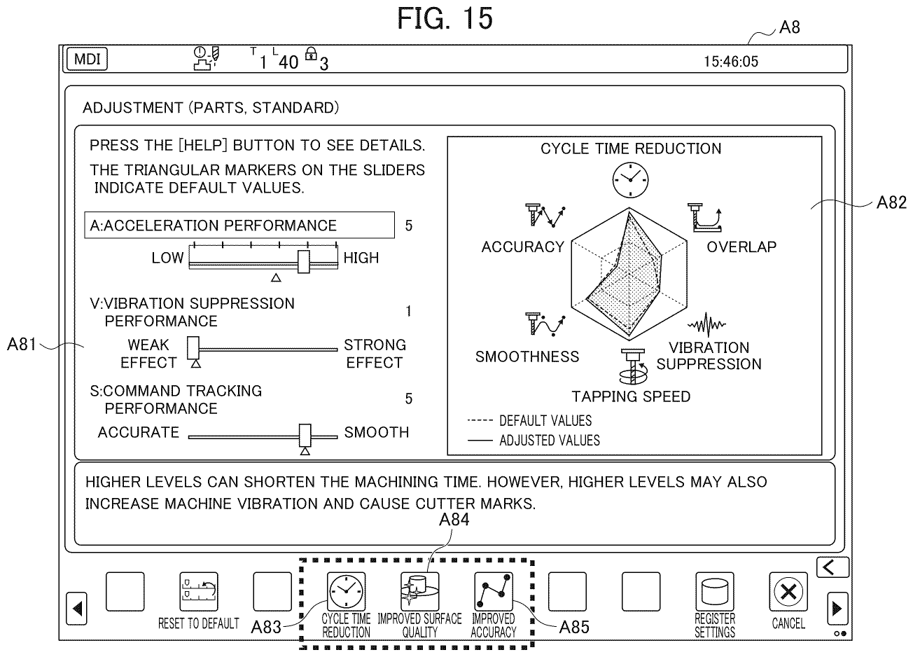

FIG. 15 shows an example of a display screen displayed after the multiple parameters of the machining mode that are related to the indicator “Cycle time reduction” have been collectively adjusted. As shown in FIG. 15, the machining mode adjustment unit 14 automatically collectively adjusts the multiple parameters of the machining mode that are related to the indicator “Cycle time reduction” (see the image A81 in FIG. 15), and the display control unit 15 reflects the changes in the multiple parameters of the machining mode in the radar chart (see the image A82 in FIG. 15). Furthermore, the machining mode adjustment unit 14 may be set to automatically further collectively adjust, upon the input reception unit 12 receiving an operation of the image A83 from the user again, the multiple parameters of the machining mode that are related to the indicator “Cycle time reduction” for further reducing the cycle time.

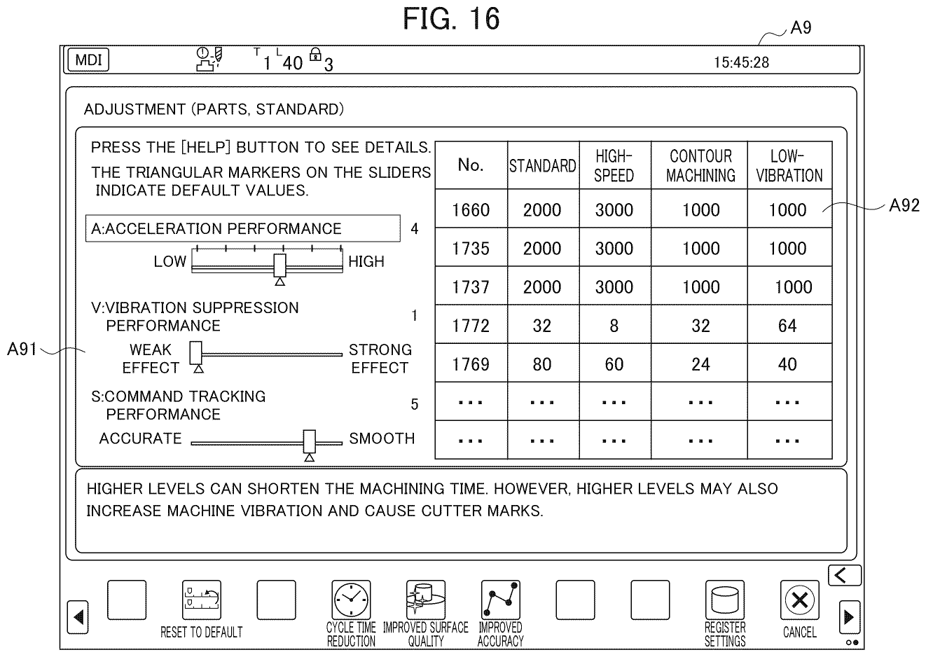

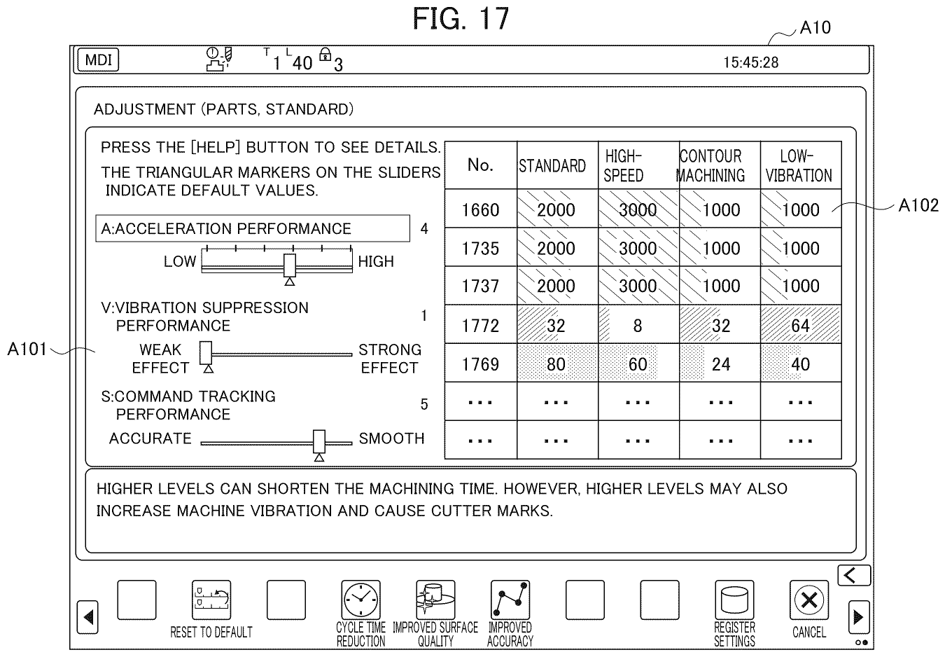

Furthermore, the display control unit 15 displays a list of parameters or a comparison table of parameters along with the adjustment image according to variations of the parameters of the machining mode. FIG. 16 shows an example of a list of parameters. FIG. 17 shows an example of a comparison table of parameters. A display screen A9 shown in FIG. 16 includes an image A91 that is displayed on the left side of the screen and includes sliders for adjusting parameters (for example, Acceleration performance) of a machining mode, and an image A92 that is displayed on the right side of the screen and shows a list of varying parameters of the machining modes.

The image A92 shown in FIG. 16 shows numbers assigned to the parameters (for example, 1660), values of the parameters (for example, 2000) of the currently selected machining mode “Standard”, values of the parameters (for example, 3000) of the machining mode “High-speed”, values of the parameters (for example, 1000) of the machining mode “Contour machining”, and values of the parameters (for example, 1000) of the machining mode “Low-vibration”.

A display screen A10 shown in FIG. 17 includes an image A101 that is displayed on the left side of the screen and includes sliders for adjusting parameters (for example, Acceleration performance) of a machining mode, and an image A102 that is displayed on the right side of the screen and shows a list and a comparison table of varying parameters of the machining modes. The image A102 shown in FIG. 17 shows numbers assigned to the parameters and values of the parameters as in the case of the image A92 shown in FIG. 16, and further shows a bar chart for comparison of each parameter.

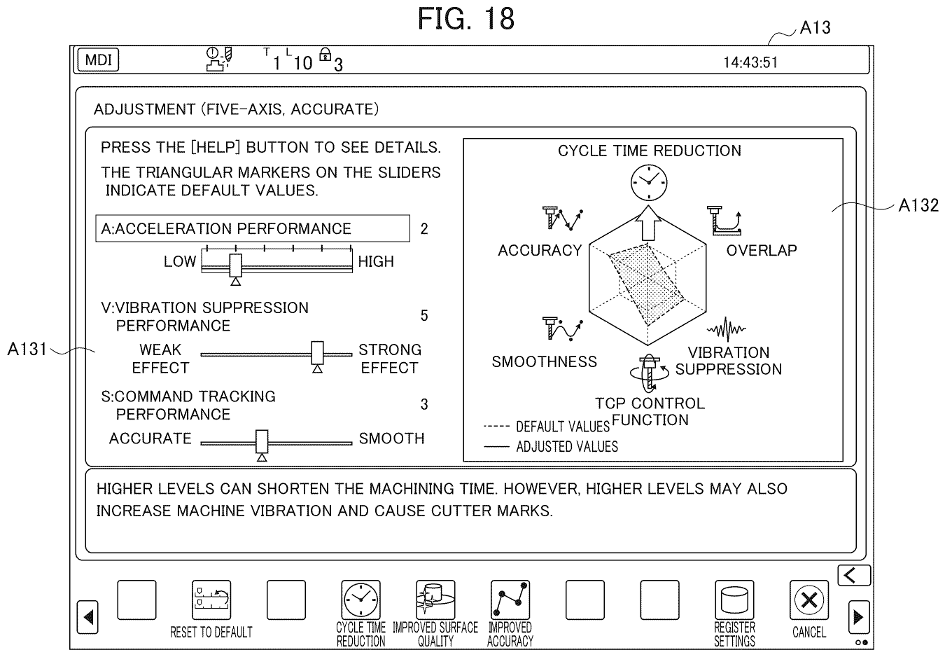

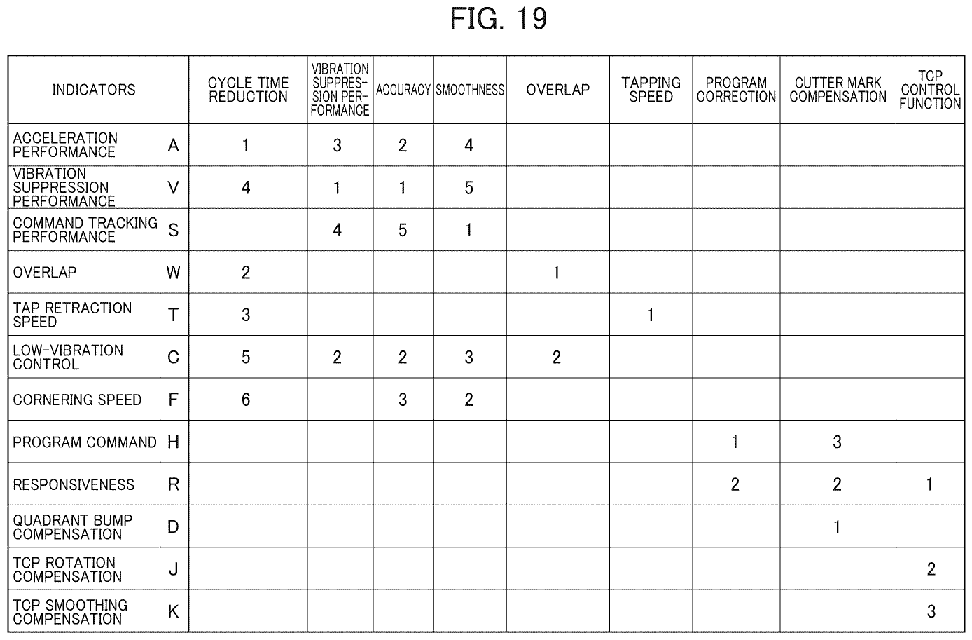

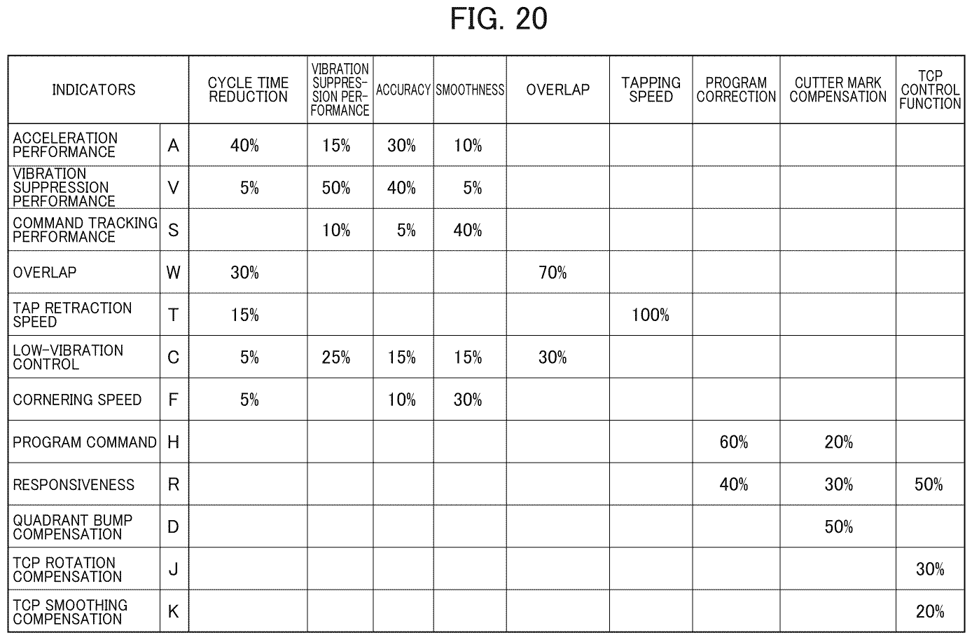

Furthermore, upon a drag or other screen operation being performed on any of the indicators displayed using a radar chart through an input from the input device 11, the display control unit 15 changes and displays parameters related to the indicator. FIG. 18 illustrates a display screen A13 displayed upon an operation being performed on an indicator displayed using the radar chart. The display screen A13 shown in FIG. 18 includes an image A131 that is displayed on the left side of the screen and includes sliders for adjusting parameters (for example, Acceleration performance) of a machining mode, and an image A132 that is displayed on the right side of the screen and shows characteristics of the machining mode using a radar chart. Upon a drag or other screen operation being performed on the indicator “Cycle time reduction” on the image A132 to increase the score of the indicator “Cycle time reduction”, the parameter setting unit 13 may recalculate the score of the indicator “Cycle time reduction” based on priority levels shown in FIG. 19 or distribution ratios shown in FIG. 20, and the display control unit 15 may change and display the parameters related to the indicator “Cycle time reduction”.

FIG. 19 shows an example of priority levels of parameters of a machining mode for each indicator. As shown in FIG. 19, the priority levels (priority rankings) of the parameters of the machining mode, such as Acceleration, Vibration suppression performance, and Command tracking performance, are set for each of the indicators, such as Cycle time reduction, Vibration suppression, and Accuracy. The priority decreases as the numerical value increases, with Priority level 1 being the highest. For example, as for parameters of the machining mode that correspond to the indicator “Cycle time reduction”, Acceleration performance is set to Priority level 1, Overlap is set to Priority level 2, Tap retraction speed is set to Priority level 3, Vibration suppression performance is set to Priority level 4, Low-vibration control is set to Priority level 5, and Cornering speed is set to Priority level 6.

For example, upon a drag or other screen operation being performed on the indicator “Cycle time reduction” on the image A132 shown in FIG. 18 to increase the score of the indicator “Cycle time reduction” from 6 to 10, the parameter setting unit 13 recalculates the score of the indicator “Cycle time reduction” based on the priority levels shown in FIG. 19.

Specifically, in view of the priority levels shown in FIG. 19, the parameter setting unit 13 adjusts Acceleration performance assigned the highest priority level (Priority level 1) by selecting a higher adjustment range level. Then, if the maximum adjustment range level of Acceleration performance has been reached but the score does not reach 10 (maximum value), the parameter setting unit 13 adjusts Overlap assigned the next highest priority level (Priority level 2) by selecting a higher adjustment range level.

FIG. 20 shows an example of distribution ratios of parameters of a machining mode for each indicator. As shown in FIG. 20, the distribution ratios (%) of the parameters of the machining mode, such as Acceleration, Vibration suppression performance, and Command tracking performance, are set for each of the indicators, such as Cycle time reduction, Vibration suppression, and Accuracy. For example, as for parameters of the machining mode that correspond to the indicator “Cycle time reduction”, Acceleration performance is set to a distribution ratio of 40%, Overlap is set to a distribution ratio of 30%, Tap retraction speed is set to a distribution ratio of 15%, Vibration suppression performance is set to a distribution ratio of 5%, Low-vibration control is set to a distribution ratio of 5%, and Cornering speed is set to a distribution ratio of 5%.

For example, upon a drag or other screen operation being performed on the indicator “Cycle time reduction” on the image A132 shown in FIG. 18 to increase the score of the indicator “Cycle time reduction” from 6 to 10, the parameter setting unit 13 recalculates the score of the indicator “Cycle time reduction” based on the distribution ratios shown in FIG. 20. Specifically, in view of the distribution ratios shown in FIG. 20, the parameter setting unit 13 adjusts the parameters (Acceleration performance, Overlap, Tap retraction speed, Vibration suppression performance, Low-vibration control, and Cornering speed) by distributing a difference (10−6=4) resulting from the score change across the parameters based on the distribution ratios, and thus selecting an adjustment range level for each parameter.

The numerical control device 1 according to the present embodiment has at least two machining modes each defining a combination of parameters of at least one of an acceleration/deceleration function, a servo function, or a compensation function required for machining with the machine tool 2, and the display control unit 15 displays, on the display device 16, a machining mode image showing characteristics of any of the machining modes in a predetermined display format recognizable by a user based on indicators related to the machining. The display control unit 15 displays an adjustment image for adjusting parameters that affect the indicators along with the machining mode image displayed in the predetermined display format. The numerical control device 1 having such a configuration makes it possible for any user to easily adjust the machining mode regardless of the user's skill level, thereby facilitating efficient machining.

The adjustment image includes one or more adjustment items for adjusting the parameters of at least one of the acceleration/deceleration function, the servo function, or the compensation function. This configuration allows the user of the numerical control device 1 to easily adjust the parameters.

The parameter setting unit 13 performs calculations of each parameter of the machining mode corresponding to the adjustment range levels for adjustment of the parameter within the adjustment range, based on a mathematical function defining the parameter and the adjustment range levels. Since the parameter and the adjustment range levels are defined by a mathematical function, the numerical control device 1 can set the levels to decimal values.

Furthermore, the machining mode adjustment unit 14 has a function for switching the adjustment range levels between integer and floating-point values. This configuration enables the numerical control device 1 to display the levels with both integer and floating-point values.

The adjustment image may be assigned one or more of alphanumeric characters and/or symbols, icons, or colors for identifying a machining type. The numerical control device 1 having such a configuration makes it possible to easily identify the machining type without the need to read the name of the machining type, allowing the user to intuitively determine a machining type corresponding to the machining.

In the machining mode image showing the characteristics of the machining mode in the predetermined display format, the display control unit 15 changes and displays one or more of chart shape, numerical value of each indicator, icon or other graphic, or color according to the parameters of the machining mode that are varied using the adjustment items. For example, the numerical control device 1 having such a configuration assigns one alphabet character that matches the machining type to the adjustment image, and the alphabet character is used as an argument for a program-based change. Thus, the user can recognize the machining type more easily.

Furthermore, the machining mode adjustment unit 14 has a function for resetting settings for the adjustment range levels to default. This configuration enables the numerical control device 1 to reset the settings for the adjustment range levels to default and newly set the levels.

Furthermore, the machining mode adjustment unit 14 has a function for inputting and outputting settings for the adjustment range levels. This configuration enables the numerical control device 1 to input and output the settings for the adjustment range levels, facilitating setting of the adjustment range levels.

Furthermore, the adjustment image may include sliders each including one of a bar, a block-style gauge, a triangular-style gauge, a cylindrical-style gauge, or a scroll bar, and the sliders may be each formed from a segmented or unsegmented triangle, rectangle, parallelogram, or cylinder. The numerical control device 1 having such a configuration makes it possible to easily adjust the machining mode.

Furthermore, the adjustment image includes markers indicating default values of the parameters of the machining mode. This configuration allows the user of the numerical control device 1 to easily know the default values of the parameters.

Furthermore, the machining mode adjustment unit 14 may have a function for collectively adjusting multiple parameters of the machining mode. This configuration allows the user of the numerical control device 1 to collectively adjust parameters of the machining mode that correspond to any of the indicators.

Furthermore, the display control unit 15 displays a list of parameters or a comparison table of parameters along with the adjustment image according to variations of the parameters of the machining mode. This configuration allows the user of the numerical control device 1 to easily know the machining mode and variations of the parameters of the machining mode.

Furthermore, upon a drag or other screen operation being performed on any of the indicators displayed using a radar chart through an input from the input device 11, the display control unit 15 changes and displays parameters related to the indicator. This configuration allows the user of the numerical control device 1 to easily know variations of the parameters related to the indicator.

Embodiments of the present invention have been described above. The numerical control device 1 described above can be implemented by hardware, software, or a combination thereof. A control method that is carried out by the numerical control device 1 described above can also be implemented by hardware, software, or a combination thereof. Being implemented by software herein means being implemented through a computer reading and executing a program.

The program can be supplied to the computer by being stored on any of various types of non-transitory computer readable media. The non-transitory computer readable media include various types of tangible storage media. Examples of the non-transitory computer readable media include magnetic storage media (such as hard disk drives), magneto-optical storage media (such as magneto-optical disks), compact disc read only memory (CD-ROM), compact disc recordable (CD-R), compact disc rewritable (CD-R/W), and semiconductor memory (such as mask ROM, programmable ROM (PROM), erasable PROM (EPROM), flash ROM, and random access memory (RAM)).

Although the present disclosure has been described in detail above, the present disclosure is not limited to the foregoing individual embodiments. Various changes, such as additions, substitutions, alterations, and partial omissions, may be made to the foregoing embodiments to the extent that such changes do not depart from the gist of the present disclosure, or to the extent that such changes do not depart from the gist of the present disclosure that is derived from the appended claims or the equivalents thereof. Any of the foregoing embodiments can be implemented in combination with each other. For example, the order of operations and the order of processes mentioned in the foregoing embodiments are merely examples, and the present disclosure is not limited thereto. The same applies to numerical values or mathematical formulas that are used in the description of the foregoing embodiments, if any.

The following further discloses additional remarks regarding the foregoing embodiments and modification examples thereof.

### Additional Remark 1

A machining information display device (1) having at least two machining modes each defining a combination of parameters of at least one of an acceleration/deceleration function, a servo function, or a compensation function required for machining with a machine tool, the machining information display device including a display control unit (15) that displays, on a display device, a machining mode image showing characteristics of any of the machining modes in a predetermined display format recognizable by a user based on indicators related to the machining, wherein the display control unit displays an adjustment image for adjusting parameters that affect the indicators along with the machining mode image displayed in the predetermined display format.

### Additional Remark 2

The machining information display device according to Additional Remark 1, wherein the adjustment image includes one or more adjustment items for adjusting the parameters of at least one of the acceleration/deceleration function, the servo function, or the compensation function.

### Additional Remark 3

The machining information display device according to Additional Remark 1 or 2, further including a parameter setting unit (13), wherein
adjustment range levels are set for adjustment of each of the parameters of the machining mode within an adjustment range, and
the parameter setting unit performs calculations of the parameter of the machining mode corresponding to the adjustment range levels based on a mathematical function defining the parameter of the machining mode and the adjustment range levels.

### Additional Remark 4

The machining information display device according to Additional Remark 3, further including a machining mode adjustment unit (14) that has a function for switching the adjustment range levels between integer and floating-point values.

### Additional Remark 5

The machining information display device according to Additional Remark 1 or 2, wherein the adjustment image is assigned one or more of: an alphanumeric character and/or a symbol, an icon, or a color for identifying a machining type related to the machining.

### Additional Remark 6

The machining information display device according to Additional Remark 1 or 2, wherein in the machining mode image showing characteristics of the machining mode in the predetermined display format, the display control unit changes and displays one or more of: a chart shape, a numerical value of each indicator, an icon or other graphic, or a color according to the parameters of the machining mode that are varied using the adjustment items.

### Additional Remark 7

The machining information display device according to Additional Remark 3, further including a machining mode adjustment unit (14) that has a function for resetting settings for the adjustment range levels to default.

### Additional Remark 8

The machining information display device according to Additional Remark 3, further including a machining mode adjustment unit (14) that has a function for inputting and outputting settings for the adjustment range levels.

### Additional Remark 9

The machining information display device according to Additional Remark 1 or 2, wherein
the adjustment image includes sliders each including one of a bar, a block-style gauge, a triangular-style gauge, a cylindrical-style gauge, and a scroll bar, and
the sliders are each formed from a segmented or unsegmented triangle, rectangle, parallelogram, or cylinder.

### Additional Remark 10

The machining information display device according to Additional Remark 1 or 2, wherein the adjustment image includes markers indicating default values of the parameters of the machining mode.

### Additional Remark 11

The machining information display device according to Additional Remark 1 or 2, further including a machining mode adjustment unit that has a function for collectively adjusting multiple parameters of the machining mode.

### Additional Remark 12

The machining information display device according to Additional Remark 1 or 2, wherein the display control unit displays a list of varying parameters of the machining modes or a comparison table of varying parameters of the machining modes along with the adjustment image according to variations of the parameters of the machining mode.

### Additional Remark 13

The machining information display device according to Additional Remark 1 or 2, wherein upon an operation being performed on any of the indicators displayed in the predetermined format, the display control unit changes and displays parameters related to the indicator.
1: Numerical control device
2: Machine tool
11: Input device
12: Input reception unit
13: Parameter setting unit
14: Machining mode adjustment unit
15: Display control unit
16: Display device

1. A machining information display device having at least two machining modes each defining a combination of parameters of at least one of an acceleration/deceleration function, a servo function, or a compensation function required for machining with a machine tool, the machining information display device comprising a display control unit that displays, on a display device, a machining mode image showing characteristics of any of the machining modes in a predetermined display format recognizable by a user based on indicators related to the machining,
wherein the display control unit displays an adjustment image for adjusting parameters that affect the indicators along with the machining mode image displayed in the predetermined display format.

2. The machining information display device according to claim 1, wherein the adjustment image includes one or more adjustment items for adjusting the parameters of at least one of the acceleration/deceleration function, the servo function, or the compensation function.

3. The machining information display device according to claim 1, further comprising a parameter setting unit, wherein
adjustment range levels are set for adjustment of each of the parameters of the machining mode within an adjustment range, and
the parameter setting unit performs calculations of the parameter of the machining mode corresponding to the adjustment range levels based on a mathematical function defining the parameter of the machining mode and the adjustment range levels.

4. The machining information display device according to claim 3, further comprising a machining mode adjustment unit that has a function for switching the adjustment range levels between integer and floating-point values.

5. The machining information display device according to claim 1, wherein the adjustment image is assigned one or more of: an alphanumeric character and/or a symbol, an icon, or a color for identifying a machining type related to the machining.

6. The machining information display device according to claim 2, wherein in the machining mode image showing characteristics of the machining mode in the predetermined display format, the display control unit changes and displays one or more of: a chart shape, a numerical value of each indicator, an icon or other graphic, or a color according to the parameters of the machining mode that are varied using the adjustment items.

7. The machining information display device according to claim 3, further comprising a machining mode adjustment unit that has a function for resetting settings for the adjustment range levels to default.

8. The machining information display device according to claim 3, further comprising a machining mode adjustment unit that has a function for inputting and outputting settings for the adjustment range levels.

9. The machining information display device according to claim 1, wherein
the adjustment image includes sliders each including one of a bar, a block-style gauge, a triangular-style gauge, a cylindrical-style gauge, or a scroll bar, and
the sliders are each formed from a segmented or unsegmented triangle, rectangle, parallelogram, or cylinder.

10. The machining information display device according to claim 1, wherein the adjustment image includes markers indicating default values of the parameters of the machining mode.

11. The machining information display device according to claim 1, further comprising a machining mode adjustment unit that has a function for collectively adjusting multiple parameters of the machining mode.

12. The machining information display device according to claim 1, wherein the display control unit displays a list of varying parameters of the machining modes or a comparison table of varying parameters of the machining modes along with the adjustment image according to variations of the parameters of the machining mode.

13. The machining information display device according to claim 1, wherein upon an operation being performed on any of the indicators displayed in the predetermined format, the display control unit changes and displays parameters related to the indicator.
